(19) United States
(12) Patent Application Publication
(10) Pub. No.: US 2014/0278696 A1
(43) Pub. Date: Sep. 18, 2014

(54) METHODS AND APPARATUS TO DETERMINE WORK PATHS FOR MACHINES

(71) Applicant: DEERE & COMPANY, Moline, IL (US)

(72) Inventor: Noel Wayne Anderson, Fargo, ND (US)

(73) Assignee: Deere & Company, Moline, IL (US)

(21) Appl. No.: 13/839,391

(22) Filed: Mar. 15, 2013

(51) Int. Cl. G06Q 10/06

(52) U.S. Cl. CPC G06Q 10/06313
USPC 705/7.23

(57) ABSTRACT

Methods and apparatus are disclosed for determining a work path for a machine. An example method disclosed herein includes determining whether the auxiliary machine is to assist the host machine in a plurality of work cells in a work area; based on determining whether the auxiliary machine is to assist the host machine in one of the plurality of work cells, assigning an auxiliary power mode for the one of the plurality of work cells, the auxiliary power mode comprising one of a neutral mode or a power assist mode; and in power assist mode, controlling the auxiliary machine to provide auxiliary tractive power in one of the plurality of work cells, and in neutral mode, controlling the auxiliary machine to free wheel in another one of the plurality of work cells.

### FIELD OF THE INVENTION

This disclosure relates generally to machines, and, more particularly, methods and apparatus to determine work paths for machines.

### BACKGROUND

A machine for construction, agricultural, or domestic applications may be powered by an electric motor, an internal combustion engine, or a hybrid power plant including an electric motor and an internal combustion engine. For example, in agricultural uses an operator may control the machine to harvest crops and/or plant seed, or accomplish some other task in a work area.

### SUMMARY

An example method disclosed herein includes determining whether the auxiliary machine is to assist the host machine in a plurality of work cells in a work area; based on determining whether the auxiliary machine is to assist the host machine in one of the plurality of work cells, assigning an auxiliary power mode for the one of the plurality of work cells, the auxiliary power mode comprising one of a neutral mode or a power assist mode; and in power assist mode, controlling the auxiliary machine to provide auxiliary tractive power in one of the plurality of work cells, and in neutral mode, controlling the auxiliary machine to free wheel in another one of the plurality of work cells.

An example apparatus disclosed herein includes a power selector to determine whether the auxiliary machine is to assist the host machine in a plurality of work cells in a work area, and, based on whether the auxiliary machine is to assist the host machine in one of the plurality of work cells, to assign an auxiliary power mode for the one of the plurality of work cells, the auxiliary power mode comprising one of a neutral mode or a power assist mode; and a controller to control the auxiliary machine in power assist mode to provide auxiliary tractive power in one of the plurality of work cells and to control the auxiliary machine in neutral mode to free wheel in another one of the plurality of work cells.

An example machine readable storage medium is disclosed herein having machine readable instructions which when executed cause a machine to determine whether the auxiliary machine is to assist the host machine in a plurality of work cells in a work area; based on determining whether the auxiliary machine is to assist the host machine in one of the plurality of work cells, assign an auxiliary power mode for the one of the plurality of work cells, the auxiliary power mode comprising one of a neutral mode or a power assist mode; and in power assist mode, control the auxiliary machine to provide auxiliary tractive power in one of the plurality of work cells, and in neutral mode, control the auxiliary machine to free wheel in another one of the plurality of work cells.

### BRIEF DESCRIPTION OF THE DRAWINGS

FIG. 1 is a diagram of an example machine configuration that may implement or utilize path planning methods and apparatus constructed in accordance with the teachings of this disclosure.

FIG. 2 is a block diagram of an example path planning system for determining a work path of a machine to reduce or minimize costs according to the present disclosure.

FIG. 3 is a flow chart of an example method, which may be implemented using machine readable instructions, for determining a work path for reducing or minimizing one or more costs to complete a task for a work area in accordance with the present disclosure.

FIG. 4 is a topographical map of an example work area including defined work cells for the work area.

FIG. 5 is a chart showing the elevations of an example of a work segment of the work area in FIG. 5 divided into work cells and potential operating modes of an example machine traveling in two directions over the work cells.

FIGS. 6 and 7 are topographical maps and illustrate potential work paths for traversing a topographical map of an example work area with geographic contours.

FIG. 8 is a diagram of an example machine that may implement or utilize the example path planning system of FIG. 2 to select a work path for traversing the work areas of FIGS. 4-6.

FIG. 9 is a block diagram of an example processor platform to execute or utilize the method of FIG. 3 and other methods to implement the example path planner of FIG. 2.

### DETAILED DESCRIPTION

Methods and apparatus for planning a path for a machine to traverse a work area are disclosed herein. Example methods disclosed herein for planning a path for a machine include dividing a work area into one or more work cell(s) and determining potential work paths between the one or more work cell(s). Example methods further include determining cost factors for the one or more work cells associated with operating the machine in several directions defined by the potential work paths through the one or more work cell(s). Example methods further include assigning a power mode for the one or more work cell(s) for one or more potential work path(s) based on the cost factors and estimating a cost for the one or more work path(s) for operating the machine based on the power mode associated with the one or more work cells. Example methods further include selecting a preferential work path based on the cost for the one or more work path(s).

In some examples, determining the cost factors include, but is not limited to, analyzing an estimated load of the machine and/or any units connected to the machine while traversing the corresponding work cell, estimated time for traversing the corresponding work cell, and/or estimated available power remaining in at least one of the machine and/or a second machine connected to the machine while traversing the corresponding work cell.

Assigning a power mode associated with operating the machine in several directions through the work cells may include assigning one or more of a neutral mode, a regenerative braking mode, a power assist mode, an essential assist mode, a charge stop mode, or a forbidden mode to be implemented in the corresponding work cell based on estimated traction or power for the machine to traverse the work cell or potential work path.

In some examples, estimating costs for each of the potential work paths includes calculating an estimated energy consumption and/or estimated energy generation for the machine and/or a second machine connected to the machine. The preferential work path may be the potential work path with a lowest estimated energy consumption or a highest estimated energy generation.

FIG. 1 is an illustrated example of a machine configuration 100 including a host machine 110 and an auxiliary machine 120. Other machine configurations are possible, including machine configurations that do not include the auxiliary machine 120. The machine configuration 100 may be used in conjunction with path planning methods and apparatus in accordance with the teachings of this disclosure. In the illustrated example, the host machine 110 includes a connector 117 and the auxiliary machine includes a first connector 118 and a second connector 119. In the configuration shown in FIG. 1, the host machine 110 is connected to the auxiliary machine 120 via connector 117 and first connector 118. Connectors 117, 118, and 119 include at least one hitch and may include at least one coupler (e.g., mechanical PTO, hydraulic PTO, electrical PTO or connections, communication connections, control signaling connections, etc.). In some configurations, an implement (e.g., a seeder, tillage machinery, etc.) may be connected to the auxiliary machine 120 via a second connector 119. In some configurations, the implement is connected between the host machine 110 and the auxiliary machine 120 via the hitch 117 or other similar connector. Thus, to operate the implement to traverse the work cell, the host machine 110 and/or auxiliary machine may pull, push, and/or provide power to the implement. The example connectors 117 and 118 may facilitate communication between the host machine 110 and the auxiliary machine 120 such that the host machine 110 provides control signals and/or power instructions to the auxiliary machine 120 (e.g., steering controls, power controls, etc.)

The example host machine 110 includes, among other components, a path planner 102, a controller 104, machine measurement device(s) 106, an internal combustion engine (ICE) 108 and wheels 112. The example host machine 110 may also include an optional user interface 114. In some examples, the wheels 112 may be replaced by or used in addition to other one or more ground engaging element(s) (e.g., one or more tracks). The host machine 110 may also include a generator (not shown) coupled to the ICE 108 for providing off-board electrical power (high and/or low voltage).

The example controller 104 may be used in conjunction with the path planner 102 to control a machine configuration (e.g., the machine configuration 100) associated with the system 200. The example controller 104 may provide steering and/or power controls to ground implements of the machine configuration to enable the machine configuration to traverse a path selected by the path planner 102.

The example machine measurement devices 106 may be located on the host machine 110 and/or the auxiliary machine 120. In some examples, the machine measurement devices 106 may be located on a server associated with the host machine 110 and/or the auxiliary machine 120. The machine measurement devices 106 may be one or more devices and/or types of devices including a location determination unit, such as a GPS receiver to determine a location of the host machine 110 and/or auxiliary machine 120. An example GPS receiver included in the machine measurement devices 106 may include a receiver with a differential correction device or another location-determining receiver. In some examples, geographic location data created by the path planner 102 or received from the GPS receiver and/or other measurement devices 106 may take the form of a map. The measurement devices 106 of FIG. 2 may include machine gauges and sensors to determine statuses of the machine configuration 100, such as load, fuel, power levels, etc. The example machine measurement devices 106 may include sensors to determine characteristics and/or statuses of the work area such as soil conditions, topography, etc.

In the example of FIG. 1, the auxiliary machine 120 includes an ICE 128 coupled to a generator 129. Auxiliary machine 120 also includes a fuel tank (not shown) providing fuel to the ICE 128. Auxiliary machine 120 includes a battery 122 that is connected to generator 129 and one or more motor(s) 124 located on one or more of the ground engaging elements (e.g., wheels) 126. The generator 129 may be used to charge the battery 122, provide electric current to the motor(s) 124. In some examples, the auxiliary machine 120 need not include an ICE. In some examples, the path planner 102 is located on a device associated with the host machine 110 and/or auxiliary machine 120. In some examples, the path planner 102 is located onboard the auxiliary machine 120 or is located on a server communicatively coupled to a network in communication with the host machine 110 or auxiliary machine 120 or a device (e.g., a mobile phone, a personal digital assistant, a tablet computer, etc.) associated with the host machine 110 and/or the auxiliary machine 120. In some examples, the auxiliary machine 120 can include a transmission (not shown) that mechanically couples the ICE 128 to one or more ground engaging elements 126. In such examples with a transmission, the auxiliary machine 120 may not include generator 129 and/or motor(s) 124. In some examples, the motor(s) 129 may only be electric motors and not generators that are configured to provide regenerative electrical power back to the battery 122.

The machine configuration 100 for using the example path planner 102 in accordance with the present disclosure may be used to traverse a work area in a path selected by the path planner 102. The host machine 110 may be used as agricultural equipment, construction equipment, turf care equipment, etc. The host machine 110 of FIG. 1 may be operator-controlled (a machine having an operator in optional cab 120), autonomous (without an operator and/or cab), semi-autonomous or any combination of the foregoing characteristics. In some examples, the host machine 110 may be connected to a second machine having any of the above characteristics. An autonomous machine is self-guided without operator intervention or with minimal operator intervention. A semi-autonomous machine may provide guidance instructions to an operator or driver who executes the guidance instructions and may use independent judgment with respect to the instructions.

Accordingly, the path planner 102 may be used to determine and/or select a path for the machine configuration 100 to traverse a work area by providing the selected path to the user interface 114. In some examples, the path planner 102 may provide instructions to a controller 104 of the machine configuration 100 to autonomously control the machine configuration 100. The example controller 104 may use any appropriate techniques for autonomously or semi-autonomously controlling the machine configuration 100 through providing power to the wheels 112, 126 from the ICE 108, the ICE 128, and/or motor(s) 124 and steering any combination of the wheels 112, 126. The controller 104 may be located on the host machine 110, the auxiliary machine 120, and or at a separate location in communication with the host machine 110 and/or auxiliary machine 120. The example path planner 102 is used for planning a work path for the machine configuration 100. The example path planner 102 determines a number of costs (e.g., monetary, time, etc.) for potential work paths for the machine configuration 100 based on a number of cost factors (e.g., topography, soil conditions, estimated load, desired speed of operation, etc.). In some examples, the path planner 102 provides a selected work path and/or potential work paths to the user via the interface 114. Alternatively, the selected work path may be provided to the controller 104 for use or execution.

FIG. 2 illustrates a block diagram of an example path planner 102, which may be used to implement the path planner 102 of FIG. 1.

The example path planner 102 of FIG. 2 includes a communication bus 230 to facilitate communication between a data port 232, a data storage device 234, and an example path generator 240, or otherwise. The data port 232 accepts input data from the machine measurement devices 106 or other sensors/devices, the controller 104, and/or the user interface 114 via communication links 211, 216, 221, respectively. The communication links 211, 216, 221 may be wired and/or wireless communication links.

The example path generator 240 of FIG. 2 includes a machine monitor 242, a work area definer 244, a path definer 246, a cost analyzer 250, a path selector 256, and a mapper 258. The cost analyzer 250 includes a power mode selector 252 and a cost estimator 254.

The machine monitor 242 of FIG. 2 uses input data from the user interface 114 related to a task (e.g., harvesting, plowing, mowing, planting, etc.) that the machine is to perform in the work area. In some examples, the machine monitor 242 determines the task based on the type of equipment (e.g., a plow, planter, sprayer, or header) in use by the machine configuration 100. The machine monitor 242 monitors status of several characteristics of the machine configuration 100 received from the machine measurement devices 106. The characteristics of the machine configuration 100 may include, but are not limited to, energy levels of any electric storage devices (e.g., the battery 122), hydraulic fluid accumulators, flywheels, fuel levels, load levels, etc. The machine monitor 242 may track and/or store the above characteristics for a given task versus geographical position measurements also received from a GPS receiver of the machine measurement devices 106, in order to develop a historical record to provide to the work area definer 244 and/or cost analyzer 250.

The example work area definer 244 of FIG. 2 uses input data from the data port 232 to define a data representation of a work area of the machine 100 in accordance with one or more of several techniques described herein. In some examples, a user manually inputs a boundary of the work area and topographic data on the work area from a topographic map, a topographic survey, or from another available source via the user interface 114. The user may input data files via the user interface or a removable storage device (e.g., CD-ROM drive, DVD drive, flash drive, etc.) implemented by the data storage device 234. The user may define one or more boundaries of a work area by directing the machine devices 240 (e.g., a GPS receiver) around a perimeter of the work area, allowing the work area definer 244 to determine the work area based on measurements provided by the machine measurement devices 106. The user may define the interior of the work area by controlling the host machine 110 and/or the auxiliary machine 120 and manually or automatically taking elevation and/or surface conditions (e.g., dirt, mud, snow, vegetation, etc.) with corresponding position measurements (e.g., geographic coordinates) via the machine measurement devices 106 (e.g., a GPS receiver with differential correction, a GPS receiver without differential correction or an optical measurement device). In some examples, the work area definer 244 may retrieve work area data (such as an agronomic prescription, topographical data, historical usage data including energy usage, etc.) stored from a previous task performed by the machine configuration 100 or another machine from the data storage device 234. In some examples, the work area data is recorded by the machine measurement devices 106 during performance of a previous task and the work area is defined based on the work area data from the previous task and the current task.

The example path definer 246 receives the definition of a work area from the work area definer 244. The work path definer 246 determines potential work paths for the machine configuration 100 to traverse and/or complete a task for the entire work area or a portion of the work area. Each potential work path defined by the path definer 246 determines one or more directions of travel for the machine configuration 100 to traverse work cells of the potential work path. In some examples, the desired portion of the work area may include the work area less any obstacle, obstruction, unsafe region, and/or excluded zone, which may be designated as forbidden by the path generator 240, as disclosed herein. Each proposed work path may include a series of generally parallel rows along selected and/or proposed directions. The path definer 246 may also take into account whether a crop, such as a row crop, is present in the work area. Although a user/operator may define the desired portion of the work area, the path planner 102, using the path definer 246 and/or cost analyzer 250, may cooperate with an obstruction avoidance system or a safety system to define or modify the desired portion of the work area.

The example cost analyzer 250 receives the definition of a potential work path from the work path definer 246 and machine status or characteristics from the machine monitor 242. The cost analyzer 250 determines a power mode via power mode selector 252 and estimates cost factors of each work cell via cost estimator 254, as disclosed herein, for each work cell of a potential path based on the direction of travel through the work cells. The power mode determines how the auxiliary machine 120 utilizes its power sources (e.g., the electric motor/generators 124, the ICE 128 and generator 129, etc.) to traverse a work cell. The power mode selector 252 may select an auxiliary power mode for the auxiliary machine 120 from one or more of a neutral mode, a regenerative braking mode, a power assist mode, an essential assist mode, a charge stop mode, and/or a forbidden mode, though other modes may be considered. In some examples, the cost analyzer 250 confirms that the machine 100 has adequate power to traverse the potential work path and may then alter the power mode selected by power mode selector 252 to ensure the host machine 110 with the assistance of the auxiliary machine 120 has enough power and/or traction to traverse the potential work path. The cost analyzer 250 estimates one or more costs for the machine configuration 100 to traverse each of the potential work paths defined by path definer 246. The one or more costs may include without limitation fuel, labor, machine wear, and agronomic impacts.

The cost analyzer 250 uses an example power mode selector 252 in order for the cost estimator 254 to estimate a total cost factor value for each work cell of the potential work path. The power mode selector 252 considers the analyzed cost factors and determines one or more potential power modes for an example electric drive (e.g., the motor(s) 124) of the auxiliary machine 120 to use in each work cell of the potential paths. Accordingly, the selected power mode determines how the auxiliary machine 120 is controlled. Based on the analyzed cost factors, the power mode selector 252 may choose from at least one of a neutral mode, regenerative braking mode, power assist mode, essential assist mode, charge stop mode, and/or a forbidden mode; each of these modes is described herein. Other modes may additionally and/or alternatively be used.

The power mode selector 252 may select a neutral mode for a work cell of a potential work path when the cost analyzer 250 determines that the geographic features of the work cell include a generally flat and/or slightly sloped surface. Further, the cost analyzer 250 may determine that the ICE 108 of the host machine 110 has suitable power (beyond traction and/or payload needs) to recharge an electric storage device (e.g., the battery 122), if needed at any time for the remainder of a potential work path. In neutral mode, the motor(s) 124 of the auxiliary machine 120 are “free-wheeling” as they are neither providing power nor braking. In some examples, neutral mode may also allow for the electric drive to engage, discharging available energy, if an opportunity to recharge the electric storage through regenerative braking opportunity, disclosed herein, lies ahead in work cells of the corresponding potential work path, thus potentially saving unnecessary fuel from being used by the ICE 108 and/or the ICE 128.

The power mode selector 252 may select a regenerative braking mode for a work cell of a potential work path when the cost analyzer 250 determines that the geographic features include a declining contour in the work cell. In the regenerative braking mode, the motor(s) 124 of the auxiliary machine 120 enter a braking mode effectively slowing the machine configuration 100 while also charging the battery 122. Therefore, the machine configuration 100 can safely descend a downhill grade and generate additional energy that can be used in upcoming work cells of the corresponding potential work path.

The power mode selector 252 may select a power assist mode for a work cell of a potential work path when the cost analyzer 250 determines that the geographic features include an inclining contour and/or unstable surface conditions (e.g., mud, vegetation, snow, etc.). In such examples, the power assist mode is selected if the ICE 108 of the host machine 110 is able to provide enough traction and payload power by itself, although, the machine configuration 100 would perform at a slower rate, thus affecting costs such as time and/or labor. In some examples, the inclining contour and/or unstable surface conditions are determined based on user input and/or sensors located throughout the work area or on the machine configuration 100. For example, sensors detecting moisture in the soil may be used to determine the surface conditions of the work cell. In some examples, weather services or forecasts may be used by the machine measurement devices 106 to determine surface conditions (e.g., recent precipitation would indicate muddy conditions; recent arid weather would indicate firm surface conditions, etc.).

Accordingly, in power assist mode, the auxiliary machine 120 assists the host machine 110 in traversing the cell by providing additional power for traction, implement operation, and/or payload operation via the motor(s) 124, provided that enough power remains in the battery 122 and/or fuel supply of the ICE 128 of the auxiliary machine 120 to traverse the corresponding potential work path.

The power mode selector 252 may select an essential assist mode for a work cell of a potential work path defined by path definer 246 when the cost analyzer 250 determines that the geographic features include an inclining contour and/or unstable or difficult surface conditions (e.g., mud, vegetation, snow, etc.) in the work cell and the ICE 108 of the host machine 110 cannot provide adequate power for traction, implement operation, and/or payload operation to traverse the work cell at a given speed, or any speed, without assistance. In other words, the host machine 110 would not be able to solely traverse the work path (e.g., work the implement to traverse the work path) without assistance from the auxiliary machine 120. Accordingly, in essential assist mode, the auxiliary machine 120 provides additional power for traction, implement operation, and/or payload operation to assist the host machine 110 via one or more of the motor(s) 124 to enable the machine configuration 100 to traverse the work cell and/or potential work path.

The power mode selector 252 may select a charge stop mode for a work cell of a potential work path defined by path definer 246 when the cost analyzer 250 determines that an upcoming work cell of the potential work path may require an essential assist but the auxiliary machine 120 may not have adequate energy stored in the battery 122 or fuel tank to traverse the work cell in power assist mode. Accordingly, in charge stop mode, the machine host machine 110 may charge the battery 122 using power from the ICE 108 and/or the ICE 128 and/or an external power source.

The power mode selector 252 may select a forbidden mode for a work cell of a potential work path defined by path definer 246 when the cost analyzer 250 determines that the machine configuration 100 traversing the work cell would violate an operating rule. As an example, the potential work path may require the machine configuration 100 to traverse the work cell in a direction where geographic features, such as a steep side slope, would cause a tipping hazard. In the provided example, the work cell cannot be traversed in the direction defined by the potential work path provided by path definer 246, and the corresponding potential work path may be altered through adjacent work cells of the forbidden cell (e.g., work cells that share a border with the forbidden cell) and further analyzed by the cost analyzer 250. In such examples, the cost analyzer 250 improves safety operations and assists in defining and/or determining limits of operability for the machine configuration 100.

Accordingly, the power mode selector 252 may select power modes based on simulations of operating the machine configuration 100 through each work cell in different directions defined by each corresponding potential work path. The simulations may include without limitation vehicle models, payload models, logistics models, topography models, soil models, tractive surface models, and/or vegetation models.

Within the described simulations, the example power mode selector 252, and subsequently, the cost analyzer 250 may determine which power modes are feasible, possible, and/or most optimal from a cost standpoint, as described herein.

The example cost estimator 254 of FIG. 2 may receive the power mode selections for each of the potential work paths defined by path definer 246 from power mode selector 252. The cost estimator 254 may then estimate a cost based on several cost factors provided by the machine monitor 242 and/or the power mode selector 252. Based on the selected power mode from power mode selector 252 and the machine characteristics (e.g., load, fuel and energy levels, etc.) received from the measurement devices 106 and/or the machine monitor 242, the cost estimator 254 can estimate a cost for the machine configuration 100 to traverse each work cell of each potential work path defined by work path definer 246.

The cost estimator 254 may analyze several different cost factors for each potential work path, including geographic features (e.g., elevation data, topographic data, surface conditions, etc.) associated with different cells in the work area and/or machine characteristics received from the machine monitor 242. For example, if the geographic features indicate that the work cell is generally flat or planar with optimal surface conditions, the cost factors associated with operation of the machine in that work cell may vary insignificantly. As another example, if the geographic features indicate that the work cell has a slope and/or unstable surface conditions (such as mud, snow, vegetation, etc.), the cost factors associated with operating the machine through that cell may vary significantly depending the direction of travel through that cell of the work area. In such examples, the cost estimator 254 may use a minimum stored energy reserve threshold for determining costs when the vehicle finishes traversing an essential traction assist cell for the expected or average case.

The status of the above machine characteristics received from the measurement devices 106 via the machine monitor 242 may affect the cost factors for the machine configuration 100 to traverse the work cell based on the directions defined by a potential work path. For example, the cost estimator 254 analyzes the load, available fuel, and/or energy levels of the machine configuration 100 to make a determination of whether the machine configuration 100 and/or the host machine 110 alone has enough power to traverse one or more work cells of a potential work path based on the direction of travel. If for example the host machine 110 cannot traverse the work cell in one direction defined by the potential work path, the host machine 110 may be able to traverse the work path in the opposite direction, due to a possible change in slope. For example, if the host machine 110 were able to travel downhill, rather than uphill, the host machine 110 would not need to rely on additional power from the auxiliary machine 120, because gravity would likely provide enough assistance and may allow for charging the battery 122 of the auxiliary machine 120 through the use of regenerative braking.

The example cost analyzer 250 of FIG. 2 determines one or more costs corresponding to potential work paths to traverse the work area and/or complete a task for the work area. The cost analyzer 250 may aggregate the determined cost factors estimated by the cost estimator 254 associated with operating the machine configuration 100 through the work cells of the corresponding potential work path and may provide one or more costs for each potential work path to the path selector 256 and/or the user interface 114.

The example path selector 256 of FIG. 2 receives estimated costs determined by the cost analyzer 250 for each of the potential work paths defined by work path definer 246. The path selector 256 may select a path based on the costs associated with each of the potential work paths and inputs received from the user interface 114. In some examples, the user may select which costs (e.g., monetary, time, labor, energy, etc.) the path generator 240 should prioritize in selecting a work path for an example machine configuration 100. The path selector 256 may then select the potential work path that minimizes the user selected cost. In some examples, a potential work path may be the minimum for one cost (e.g., monetary), but not the minimum for another cost (e.g., time). Once a potential work path has been selected, the path selector 256 then forwards the selected path data to the mapper 258.

The example mapper 258 of FIG. 2 receives the path data from the path selector 256. In some examples, the mapper 258 generates a graphical representation of the selected path received from the path selector 256 and/or potential work paths received from the path definer 246 for display on the user interface 114. In some examples, the mapper 258 generates control information to be provided to a machine controller, which may then be used to control the example machine configuration 100 to traverse a work area and/or complete a task for the work area.

The example user interface 114, which may be used to implement the user interface 114 of FIG. 1, is communicatively coupled to the example path planner 102. The user interface 114 of FIG. 2 supports user input, output, or both. The user interface 114 may include one or more of a keyboard, a keypad, a pointing device, a mouse, a touchscreen, a display, etc. The user interface 114 may allow a user to define or modify a data representation of a work area by describing points on a perimeter of the work area.

In some examples, one or more of the path planner 102, machine measurement devices 106, or user interface 150 may be geographically separated from the example machine configuration 100. For example, the path planner 102, the machine measurement devices 106, and/or the user interface 114 may be located at a central facility (e.g., a farm building near the work area). In the described example, a user may use the path generator 240 to generate potential work paths or select a work path for the machine configuration 100 to follow for a future task to be completed at the work area. In some examples, the selected path and/or potential paths may be wirelessly communicated to the machine configuration 100 via a wireless communication link (e.g., Bluetooth, wireless local area network (LAN), cellular network, etc.).

In the illustrated example of FIG. 2 the path planner 102 is located onboard the host machine 110 of the machine configuration 100 of FIG. 1. Additionally or alternatively, the system 200 may be located partially or entirely on the auxiliary machine 120 or at least partially separate from the machine configuration 100. In some examples, the path planner 102 is at least partially located on a server in communication with an example network (e.g., a local area network (LAN), a wireless area network (WAN), the Internet, etc.), and the network is capable of communicating with the measurement devices 106, the controller 104, and/or the user interface 114 of the machine configuration 100 via the data port 232 using the respective communication links 211, 216, 221.

While an example manner of implementing the path planner 102 of FIG. 1 has been illustrated in FIG. 2, one or more of the elements, processes and/or devices illustrated in FIG. 2 may be combined, divided, re-arranged, omitted, eliminated and/or implemented in any other way. Further, the machine monitor 242, the work area definer 244, the path definer 246, the power mode selector 252, the cost estimator 254, the cost analyzer 250, the path selector 256, the mapper 258 and/or, more generally, the path generator 240 of FIG. 2 may be implemented by hardware, software, firmware and/or any combination of hardware, software and/or firmware. Thus, for example, any of the machine monitor 242, the work area definer 244, the path definer 246, the power mode selector 252, the cost estimator 254, the cost analyzer 250, the path selector 256, the mapper 258 and/or, more generally, the path generator 240 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the machine monitor 242, the work area definer 244, the path definer 246, the power mode selector 252, the cost estimator 254, the cost analyzer 250, the path selector 256, the mapper 258 are hereby expressly defined to include a tangible computer readable storage medium such as a memory, a digital versatile disk (DVD), CD-ROM, Blu-ray, etc. storing the software and/or firmware. Further still, the example path generator 240 of FIG. 2 may include one or more elements, processes and/or devices in addition to, or instead of, those illustrated in FIG. 2, and/or may include more than one of any or all of the illustrated elements, processes and devices.

A flowchart 300 representative of a process that may be implemented using example machine readable instructions stored on a tangible medium for implementing the machine monitor 242, the work area definer 244, the path definer 246, the power mode selector 252, the cost estimator 254, the cost analyzer 250, the path selector 256, the mapper 258 and/or, more generally, the path generator 240 of FIG. 2 is shown in FIG. 3. In this example, the process may be carried out using machine readable instructions, such as a program for execution by a processor such as the processor 912 shown in the example processor platform 900 discussed below in connection with FIG. 9. The program may be embodied in software stored on a tangible computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or hardware. Further, although the example program is described with reference to the flowchart illustrated in FIG. 3, many other methods of implementing the machine monitor 242, the work area definer 244, the path definer 246, the power mode selector 252, the cost estimator 254, the cost analyzer 250, the path selector 256, the mapper 258, and/or more generally the path generator 240 may alternatively be used. For example, the order of execution of the blocks may be changed, and/or some of the blocks described may be changed, eliminated, or combined.

As mentioned above, the example processes of FIG. 3 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage medium in which information is stored for any duration (e.g., for extended time periods, permanently, brief instances, for temporarily buffering, and/or for caching of the information). As used herein, the term tangible computer readable storage medium is expressly defined to include any type of computer readable storage device and/or storage disk and to exclude propagating signals.

Additionally or alternatively, the example processes of FIG. 3 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage medium in which information is stored for any duration (e.g., for extended time periods, permanently, brief instances, for temporarily buffering, and/or for caching of the information). As used herein, the term non-transitory computer readable storage medium is expressly defined to include any type of computer readable storage disk or storage device and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The example process 300 that may be executed to implement the path generator 240 of FIG. 2 is represented by the flow chart shown in FIG. 3. With reference to the preceding figures and associated descriptions, the process 300 of FIG. 3, upon execution, causes the path generator 240 to begin planning a path for the example machine configuration 100 at block 310. At block 320, the work area definer 244 defines a work area and divides the work area into a number of work cells. The work area definer 244 may define the work area based on a user inputting geographic coordinates, historical data, etc. In some examples, the machine configuration 100 may traverse the work area in any number of directions and use the machine measurement devices 106 to record the geographic coordinates, topographical information, and/or surface conditions of the work area. In some examples, the work area definer 244 may retrieve work area data previously stored in the data storage device 234.

The number, size, and or shape of the work cells of block 320 in FIG. 3 may be adjustable based on a user's preferences selected via the user interface 114. In some examples, the work area definer 244 may automatically generate the number, size, and/or shape of the work cells based on characteristics or features of the work area (e.g., topography, size, etc.). In some examples, the shape(s) of the work cells are at least one of a square, a rectangle, a triangle, a hexagon, an octagon or any other polygonal shape, creating a grid throughout the work area. The example work path definer 246 may use any representation of the work site and/or vehicle paths including without limitation rasters, arrays, cells, polygons, vectors, line segments, curves, and/or layers. In some examples, the work cells are polygons shaped ad hoc to define the work area.

At block 330 of FIG. 3, the path definer 246 defines potential work paths to traverse all or a portion of the work cells of a work area defined by work area definer 244. In some examples, the potential work paths may be generally parallel rows, described herein as work segments, completing the work area (e.g., see FIGS. 4, 6, 7). The work segments may be comprised of one or more work cells and the number of parallel work segments may be dependent on the mechanical features of an example machine (e.g. the machine configuration 100) or any implementations, machines, or vehicles connected to the machine configuration 100 (e.g., a field plow, header, snow plow, etc.). In some examples, a work segment is the width of an example tool bar of the host machine 110 orthogonal to the direction of travel. In some examples, the potential work paths may traverse some work cells of the work area defined by the work area definer 244 on one or more angles in comparison to traversing other work cells of the work area in a parallel manner. Accordingly, the example path definer 246 may define any possible number of work paths for an example machine 100 to traverse a work area and/or complete a task for a work area defined by work area definer 244.

At block 340 of FIG. 3, the cost analyzer 250 receives the potential work paths from the path definer 246 and instructs the power mode selector 252 to assign a power mode for each of the work cells. The power mode selector 252 identifies a direction that the machine configuration 100 is to travel through each work cell of the potential work paths. The cost analyzer 250 identifies cost factors, such as geographical features, including slope and/or surface conditions as disclosed herein, and machine characteristics from machine monitor 242. At block 340 of FIG. 3, the power mode selector 252 assigns an auxiliary power mode that the auxiliary machine 120 is to use based on the identified cost factors and the direction the machine configuration 100 is to traverse the work cells for each of the potential work paths.

The following example refers to FIGS. 4 and/or 5 to demonstrate an example power mode assignment of block 340. In FIG. 4, a work area 400 having a ridge 405 is divided into work cells defined by work area definer 244. FIG. 4 shows passes 410E-460E for the machine configuration 100 of FIG. 1 traveling EAST and passes 410W-460W for the machine configuration 100 traveling WEST. The passes 410E, 410W traverse work segment 410. FIG. 5 charts the work segment 410 of the work area 400 and shows the passes 410E, 410W with potential operating modes selected for work cells (1-10) by power mode selector 252 of the machine configuration 100 traveling EAST (Pass 410E) and WEST (Pass 410W).

In FIG. 5, for Pass 410E, the power mode selector 252 identifies the direction and cost factors, e.g., ground slope, surface conditions, and/or machine characteristics, from path definer 246 and cost analyzer 250. Based on substantially flat terrain of work segment 410 in work cell 1, power mode selector 252 may assign a neutral power mode, as indicated below work cell 1 of FIG. 5.

A steep incline in work cells 2 and 3 for Pass 410E is a significant cost factor that may require additional power from as the auxiliary machine 120 via motor/generators 124, and therefore, the power mode selector 252 assigns an essential assist power mode to work cells 2 and 3, as indicated. In some examples, when the power mode selector 252 determines that an essential assist mode is to be implemented by the machine configuration 100 to traverse upcoming work cells, the power mode selector 252 may reassign power modes to previous work cells to ensure that the auxiliary machine 120 has enough energy stored in the battery 122 to traverse the cell. Accordingly, in the example of FIGS. 4 and 5, the power mode selector 252 may reassign a charge stop mode to work cell 1 to ensure that the battery 122 of the auxiliary machine 120 has enough energy for the motor(s) 124 to assist the host machine 110 with added traction and/or payload operability.

In work cell 4 of the work segment 410, for Pass 410E in the example of FIGS. 4 and 5, the power mode selector 252 determines a lesser slope in comparison to work cells 2 and 3, and the estimated machine characteristics determined by the cost analyzer 250 would allow the machine host 110 to be able to traverse the work cell without additional power from the auxiliary machine 120, but at a slower rate. Accordingly, in work cell 4 of Pass 410E, the power mode selector 252 assigns a power assist mode, as indicated in FIG. 5, to engage the motor(s) 124 to provide additional power for traction and/or payload operability and prevent timing costs of working at a slower rate.

In work cells 5-10 of the work segment 410, for Pass 410E in the example of FIGS. 4, 5, the power mode selector 252 determines a declining slope for work segment 410, allowing the motor(s) 124 to operate in neutral mode, as indicated. Accordingly, the motor(s) 124 are free wheeling through work cells 5-10 of the work segment 410, thus conserving any stored energy in the battery 122 of the auxiliary machine 120 for later uses on the potential work path.

Referring now to the example machine motor(s) 124 100 traveling Pass 410W in the example of FIGS. 4 and 5, power mode selector 252 may assign a neutral mode, as indicated above in work cell 10, based on the substantially flat terrain of the work segment 410 in work cell 10. However, in work cells 9-5 of the work segment 410, the terrain of work segment 400 has a gradual incline that may slow the rate of the machine configuration 100, although the host machine 110 may be able to traverse the work cells 9-5 without added power from the auxiliary machine 120. Accordingly, the power mode selector 252 may assign a power assist mode, as indicated in FIG. 5, to engage the motor(s) 124 of the auxiliary machine 120 to provide additional power for traction and/or payload operability and minimize timing costs from working at a slower rate to work cells 9-5 of the work segment 410 for Pass 410W.

In work cell 4 of the work segment 410, for Pass 410W in the example of FIGS. 4, 5, the power mode selector 252 determines the gradual slope from work cells 9-5 of work segment 400 has leveled off, and the host machine 110 no longer requires assistance from the auxiliary machine 120 to traverse work cell 4 at a normal rate. Accordingly, the power mode selector 252 assigns a neutral power mode, as indicated in FIG. 5, for the auxiliary machine 120 in work cell 4 of the work segment 410 for Pass 410W, allowing the motor(s) 124 to conserve energy stored in the battery 122.

In work cells 3 and 2 of the work segment 410, for Pass 410W in the example of FIGS. 4 and 5, the power mode selector 252 identifies a steep decline in work segment 410 requiring the machine configuration 100 to brake. Therefore, the power mode selector 252 assigns a regenerative braking power mode to the auxiliary machine 120, as indicated in FIG. 5, to work cells 3 and 2 of the work segment 410 for Pass 410W during which the motor(s) 124 act as generators to charge the battery 122 and slow the machine configuration 100.

Finally, in work cell 1 of the segment 410 for Pass 410W, the power mode selector 252 determines that the work segment 400 has a relatively flat surface, and therefore assigns a power mode of neutral, as indicated in FIG. 5, for the auxiliary machine 120.

The illustrated example of FIG. 5 demonstrates the different power modes that may be assigned to the auxiliary machine 120 to traverse the work cells 1-10 of the work segment 410 based on the direction (EAST or WEST) of the pass (Pass 410E or Pass 410W). Although the machine configuration 100 may be able to successfully traverse the work segment 410 in either direction, the costs associated with traversing the work segment 410 may vary depending on the direction the machine travels.

Referring back now to FIG. 3, at block 350, cost estimator 254 determines costs associated with operating the machine through the work cells of each of the potential work paths. In some examples, at block 350 of FIG. 3 the cost estimator 254 considers estimated machine characteristics based on initial machine characteristics from machine monitor 242, such as load levels, fuel levels, and/or energy levels of the battery 122 of the machine configuration 100 and the task being performed by the machine configuration 100.

For example, the cost estimator 254 estimates future load levels of the machine configuration 100 when the machine is to traverse each work cell of the potential work paths. As a specific example, if the machine configuration 100 has a load of ten tons, the cost estimator 254 may determine an estimated load of twelve tons for an upcoming work cell of the potential work path. Because an increase in the expected load may have an impact on fuel consumption and/or energy needed to traverse a work cell, the cost estimator 254 may adjust the costs for the machine configuration 100 to traverse that work cell based on those machine characteristics. Therefore, several factors, including measured and estimated, may be used to determine a cost for the machine configuration 100 to traverse the work cells.

In some examples, the cost estimator 254 determines the costs for the machine configuration 100 to traverse each of the cells based on the corresponding power mode selected by power mode selector 252. Table 1 below provides example energy costs for the respective power modes.

TABLE 1

| Power Mode | Traction (KW) | Electrical (kW) |
|---|---|---|
| Essential Assist | 240 | 0 |
| Power Assist | 210 | 30 |
| Neutral | 180 | 60 |
| Regenerative Braking | −60 | 120 |
| Charge Stop | 0 | 60 |
| Forbidden | 0 | 0 |

In the example of Table 1, it is assumed that the auxiliary machine 120 can generate up to 240 kW of power which may be split between traction and generation of electrical power up to 60 kW. These values are representative of agricultural tractors used for nearly total tractive activities such as tillage. Other example activities may require consideration of other power needs such as auxiliary electric loads, auxiliary mechanical loads (e.g., power take-off), and auxiliary hydraulic fluid loads. These auxiliary power needs reduce the amount of engine power available for traction and storage.

In the illustrated example of Table 1, single values for traction power and/or power for electricity generation are given for each power mode. In some example, a number of traction and/or generation splits of engine power may be used. For example, based on topography and Table 1 values, finer resolution may be obtained by assigning a slope to each power mode in the table and then interpolating traction and generation values based on actual slope at a location. Additional resolution may be obtained by increasing the dimensions considered. For example, adding soil type, soil moisture, and equipment settings such as tillage type and depth to topography.

The allocation of engine power between traction, electrical loads, mechanical loads, hydraulic loads, etc. may be based on analysis of data collected from equipment in the field, engineering calculations, simulations, etc.

Applying the above energy costs of Table 1 to the work segment 410 of FIGS. 4 and 5, an example cost analysis of the Passes 410E, 410W follows. The following Table 2 provides example monetary costs:

TABLE 2

| Cost | Value |
|---|---|
| Labor | $12/hr |
| Fuel | $4/gal |

Assuming a fuel consumption of 3 gal/hr at 240 kW and an optimal speed of 5 mph to traverse each work cell, costs are calculated for traversing the work segment 410 of FIGS. 4 and 5. Table 3 indicates the mode (N=Neutral, EA=Energy Assist, PA=Power Assist, RB=Regenerative Braking), energy cost, time required, monetary costs, and total power needed for the machine configuration 100 to traverse Pass 410E.

TABLE 3

| | Cell | | | | | | | | | |
|---|---|---|---|---|---|---|---|---|---|---|
| | 1 | 2 | 3 | 4 | 5 | 6 | 7 | 8 | 9 | 10 |
| Mode | N | EA | EA | PA | N | N | N | N | N | N |

| | | | | |
|---|---|---|---|---|
| Energy | 180 kW | 240 kW | 210 kW | 180 kW |
| Time | 0.01 hr | 0.02 hr | 0.01 hr | 0.06 hr |
| $ | $0.09 | $0.24 | $0.11 | $0.54 |

| | |
|---|---|
| Totals: | Need 10 kWh stored and $0.98 fuel for 0.1 hr |

Referring to Table 3, for the machine configuration 100 to traverse Pass 410E of FIGS. 4 and 5, the machine configuration 100 requires 10 kWh of power and $0.98 worth of fuel. Table 4 indicates the power mode, energy cost, time required, monetary casts, and total power needed for the machine configuration 100 to traverse Pass 410W.

TABLE 4

| | Cell | | | | | | | | | |
|---|---|---|---|---|---|---|---|---|---|---|
| | 10 | 9 | 8 | 7 | 6 | 5 | 4 | 3 | 2 | 1 |
| Mode | N | PA | PA | PA | PA | PA | N | RB | RB | N |

| | | | | | |
|---|---|---|---|---|---|
| Energy | 180kW | 210 kW | 180 kW | 60 kW | 180 kW |
| Time | .01 hr | 0.05 hr | 0.01 | 0.02 | .01 hr |
| $ | $0.09 | $0.53 | $0.09 | $0.06 | $0.09 |

| | |
|---|---|
| Totals: | Recapture 5 kWh, need $0.86 fuel for 0.1 hr |

Accordingly, at block 350 of FIG. 3, the cost estimator 254 estimates the costs for the machine configuration 100 to traverse each work cell 1-10 based on the power mode selected by power mode selector 252 and machine characteristics from machine monitor 242.

At block 360, the cost analyzer 250 estimates a cost for each of the potential work paths for operating the machine configuration 100 based on the power mode associated with the machine configuration 100 in each of the work cells. In some examples, the cost analyzer 250 estimates a cost for the potential work paths by summing all costs for all cells of the work segments of the work paths, which costs may be based on alternating directions for each pass, to estimate a total cost for the potential work path (e.g., see cost analysis for FIG. 4, described herein). Using the above cost analysis in Tables 1-4, the cost analyzer 250 aggregates the costs of each of the work cells to find the total costs as provided in the last rows of Tables 3 and 4.

At block 370 of FIG. 3, the path selector 256 of the path generator 240 may compare the total costs determined by the cost analyzer 250 to select a preferential work path based on determined costs of each of the potential work paths. In some examples, the path selector 256 may select a path based on one or more specific costs (e.g., energy consumption/generation, time, monetary, labor, etc.) selected by a user via user interface 114.

Referring back to the example costs analysis from Tables 1-4, the path selector 256 compares the Totals of Tables 3 and 4, for Passes 410E, 410W of FIGS. 4, 5. Passes 410E, 410W each take 0.1 hr to traverse the work segment 410. However, 5 kWh of power is recaptured in Pass 410W, whereas 10 kWh is required for Pass 410E. Furthermore, only $0.86 of fuel is required for Pass 410W, while $0.98 of fuel is required for Pass 410E. Therefore, it is evident from the above Tables 3 and 4 that Pass 410W is the preferred path over Pass 410E to traverse the work segment 410. While the work segment 410 of FIGS. 4 and 5 is only an example portion of a potential work path, the above example of FIGS. 4 and 5 and cost analysis in Tables 3 and 4 may be applied to an entire potential work path.

Accordingly, at block 370 the path selector 256 selects a path based on the cost estimator 254 calculating the above costs for each of the work cells, and the cost analyzer 250 determining a total cost. Following the selection of a path at block 370, the path generator 240 has completed the path planning process.

At block 380 of FIG. 3, the example mapper 258 maps the selected path the machine configuration 100 and presents the selected work path and/or potential work paths for viewing on the user interface display 250.

Referring now to the example of FIG. 4, an example work area 400 defined by the work area definer 244 is topographically shown depicting a ridge 501 represented by the shaded contours (higher altitude=lighter, low altitude=darker). FIG. 4 identifies Passes 410E-460E and Passes 410W-460W for the machine configuration 100 to traverse work segments 410-460. Each of the example work segments 410-460 include ten work cells (1-10) defined by the work area definer 244.

For the following example, in FIG. 4, it is assumed that path selector 256 has determined only two potential work paths for traversing a work area 400. The potential work paths are defined as being in ascending order (Pass 410 to Pass 460) wherein the direction between adjacent passes alternate. Accordingly, for the machine configuration 100 to traverse the work area 400, the path selector 256 chooses alternating directions of travel for each of the work segments 410-460. For example, based on the two potential work paths, the path selector 256 may select Pass 410W, then 420E, but may not select Pass 410W, then 420W.

Referring to FIG. 4, the work segments 410, 420, 430 include the ridge 405. Therefore, assuming normal machine characteristics, the power mode selector 252 would likely assign an essential assist mode and/or a regenerative breaking mode to the auxiliary machine 120, as described herein, for one or more of the work cells of the work segments 410, 420, 430. The work segments 440, 450, 460 are shown as having relatively flat contours, and therefore, assuming the same normal machine characteristics, the power mode selector 252 likely assigns a neutral mode. Therefore, in the illustrated example of FIG. 4, determining the optimal path for traversing the work segments 410, 420, 430 results in determining an optimal path for traversing the work area 400.

As an example of determining the costs of traversing the work segments 410, 420, 430, of FIG. 4 the example cost analysis involving Tables 1-4 for work segment 410 in the above example may be used to analyze how the path selector 256 determines the optimal path. As determined by the cost analyzer 250 above, the optimal path for traversing the work segment 410 would be Pass 410W, thus from EAST to WEST, as shown in FIGS. 4 and 5, because Pass 410W, as opposed to Pass 410E, yields a lower cost (recapture power and requires less fuel). The work segment 420, though the same as the work segment 410, has similar features as the work segment 410. Accordingly, it is assumed that Pass 420E has similar costs traversing ridge 405 as determined for Pass 410E in the cost analysis above. In a similar fashion, Pass 430W would likely yield the similar costs as Pass 410W because Pass 430W is traversing work area 400 and ridge 405 in the same direction as Pass 410W.

Accordingly, for this example, totaling costs from Table 3 once (Pass 420E) and Table 4 twice (once for Pass 410W, once for Pass 430W), yields a total cost for traversing the work segments 410, 420, 430. For the second potential work path, assuming that the total costs apply in a similar fashion to work segment 410 of FIGS. 4 and 5, totaling costs in the opposite direction would include adding the costs from Table 3 twice (once for Pass 410E, one for Pass 430E) and Table 4 once (Pass 420W). Accordingly, the costs for the second potential path would yield a greater cost than the first determined work path for traversing the work segments 410, 420, 430. Accordingly, assuming that traversing the work segments 440, 450, 460 would yield the same costs no matter which direction they are traveled because the selected power mode for the auxiliary machine 120 would be neutral for any pass selected to traverse the work segments 440, 450, 460, the first potential work path (traversing the work segment 410 using Pass 410W) would yield lower costs than the second potential work path (traversing the work segment 420 using Pass 410E).

Referring now to FIGS. 6 and 7, two example work paths 610, 710 are provided for a machine (e.g., the machine 100) to traverse a work area 601 having a relatively consistent slope throughout the work area 601. The work area 601 is defined by contours (100-600), with 100 being low and 600 being high. Thus, the work area of 601 is located on a slope. Accordingly, the path definer 246 may determine two optimal potential work paths 610 and 710 for traversing the work area 601.

Referring to FIG. 6, the work path 610 traverses the work area 601 in horizontal work segments relative to the contours 100-600. Accordingly, the machine 100 the traverses the work area 601 in a manner that the machine 100 does not encounter any inclines or declines in the terrain aside from short moments in time to change direction. The power mode selector 252 of FIG. 2 of the machine 100 likely assigns a neutral power mode to the work cells of the horizontal work segments of the illustrated example, and may assign power assist or essential assist when the machine 100 changes direction. Accordingly, the work path 610 may not successfully optimize costs for traversing the work area 601.

Referring to FIG. 7, work path 710 substantially traverses work area 601 in vertical work segments relative to the contours 100-600. Accordingly, an example machine 100 would be traversing the work area 601 in a manner that the machine encounters the inclines and declines of the contours while traversing the work segments. In such examples, the power mode selector 252 of the machine 100 likely assigns power assist and/or essential assist to the work cells with inclines and regenerative braking to the work cells with declines of the work segments, and neutral mode to work segments in which the machine 100 is changing directions. Accordingly, because power can be regenerated on the declines, in the above examples of FIGS. 6-7, the work path 710 may have lower costs than the work path 610.

FIG. 8 illustrates an example machine 800 that may be used in conjunction with or to implement the example system 200 of FIG. 2 and or the auxiliary machine 120 of FIG. 1. The machine 800 of FIG. 8 includes, among other components, a path planner 802, a controller 804, measurement devices 806, an ICE 808, an ICE fuel tank (not shown), a generator 809, wheels 810, motor(s) 812, a battery 814, and connectors 816, 818. The machine 800 may include a user cab 820 and a user interface 850. The example ICE 808 of FIG. 8 is configured to provide power to the generator 809 which then powers the motors 812 and or generates energy for storage in the battery 814 In the illustrated example, the machine 800 may be autonomously controlled using the path planner 802 and the controller 804 and/or manually controlled by a user in the cab 820 or remotely located from the machine 800. For example, the controller 804 may receive instructions to perform a task in a work area from a user via the user interface 850 or from a network in communication with the controller 804. The path planner 802 may then determine an optimal path for the work machine 800 to traverse the work area to complete the task. The example controller 804 may receive information from measurement devices 806 as similarly described with respect to the measurement devices 106 of FIG. 1. The example measurement devices may include sensors, gauges, or navigation systems (e.g., a location determining system such as a global positioning system (GPS) receiver or other like navigation system) for autonomous operation and/or user-controlled operation. In some examples, the example controller 804 controls the power to the wheels 810. In some examples, the user can bypass the controller 804 to control the machine 800.

In some examples, the ICE 808 may be configured to provide power mechanically to the wheels 810 of the machine 800. In such examples, the controller 804 may instruct the battery 814 to provide additional power to the motor(s) 812 when the power mode selector 222 selects a power assist mode or an essential assist mode, described herein, thus increasing an overall power output to the wheels 812. Additionally, the controller 804 may instruct the motor(s) 812 to generate energy for storage in the battery 808 when the power mode selector selects a regenerative braking mode, described herein.

The ICE 808 and generator 809 may be configured to provide electric current to the motor(s) 812 to drive/engage the wheels 810. In such examples, when the power mode selector 222 selects power assist mode or essential assist mode, as described herein, the controller 804 may instruct any wheels that are free-wheeling to engage/drive in order to provide additional traction and/or payload power. The controller 804 may instruct the motor(s) 112 to enter a regenerative braking mode according to the power mode selector 222, in which case the motor(s) 112 generate energy for storage in the battery 814.

FIG. 9 is a block diagram of an example processor platform 900 capable of executing the instructions of FIG. 3 to implement the path generator 240 of FIG. 2. The processor platform 900 can be, for example, a server, a personal computer, a mobile phone (e.g., a cell phone), a personal digital assistant (PDA), an Internet appliance, or any other type of computing device.

The system 900 of the instant example includes a processor 912. For example, the processor 912 can be implemented by one or more microprocessors or controllers from any desired family or manufacturer.

The processor 912 includes a local memory 913 (e.g., a cache) and is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 also includes an interface circuit 920. The interface circuit 920 may be implemented by any type of interface standard, such as an Ethernet interface, a universal serial bus (USB), and/or a PCI express interface.

One or more input devices 922 are connected to the interface circuit 920. The input device(s) 922 permit a user to enter data and commands into the processor 912. The input device(s) can be implemented by, for example, a keyboard, a mouse, a touchscreen, a track-pad, a trackball, isopoint and/or a voice recognition system.

One or more output devices 924 are also connected to the interface circuit 920. The output devices 924 can be implemented, for example, by display devices (e.g., a liquid crystal display, a cathode ray tube display (CRT), a printer and/or speakers). The interface circuit 920, thus, typically includes a graphics driver card.

The interface circuit 920 also includes a communication device such as a modem or network interface card to facilitate exchange of data with external computers via a network 926 (e.g., an Ethernet connection, a digital subscriber line (DSL), a telephone line, coaxial cable, a cellular telephone system, etc.).

The processor platform 900 also includes one or more mass storage devices 928 for storing software and data. Examples of such mass storage devices 928 include floppy disk drives, hard drive disks, compact disk drives and digital versatile disk (DVD) drives.

The coded instructions 932, which may implement the coded instructions 300 of FIG. 3, may be stored in the mass storage device 928, in the volatile memory 914, in the non-volatile memory 916, and/or on a removable storage medium such as a CD or DVD.

From the foregoing, it will be appreciated that the above disclosed methods, apparatus and articles of manufacture provide a method and apparatus for selecting an path for one or more machines to traverse a work area defined by work cells, wherein the one or more machines have electric drives with the ability to charge, provide power, or free wheel through the work cells depending on cost factors associated with both the work area and the machine itself.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method of controlling an auxiliary machine connected to a host machine, the method comprising:
determining whether the auxiliary machine is to assist the host machine in a plurality of work cells in a work area;
based on determining whether the auxiliary machine is to assist the host machine in one of the plurality of work cells, assigning an auxiliary power mode for the one of the plurality of work cells, the auxiliary power mode comprising one of a neutral mode or a power assist mode; and
in power assist mode, controlling the auxiliary machine to provide auxiliary tractive power in one of the plurality of work cells, and in neutral mode, controlling the auxiliary machine to free wheel in another one of the plurality of work cells.

2. The method according to claim 1, wherein the auxiliary power mode comprises a regenerative braking mode, the method comprising controlling the auxiliary machine in one of the plurality of work cells to provide regenerative braking in the regenerative braking mode.

3. The method according to claim 1, wherein an implement is connected to the auxiliary machine and wherein determining whether the auxiliary machine is to assist the host machine in one of the plurality of work cells is based upon whether the host machine can solely operate the implement in the one of the plurality of work cells.

4. The method according to claim 3, wherein operating the implement comprises at least one of pulling, pushing, or providing power to the implement.

5. The method according to claim 1, wherein an implement is connected to the auxiliary machine and wherein determining whether the auxiliary machine is to assist the host machine in one of the plurality of work cells is based upon whether the host machine can solely operate the implement at a particular speed in the one of the plurality of work cells.

6. The method according to claim 1, wherein assigning the auxiliary power mode for the one of the plurality of work cells is based on determining at least one of an estimated total power consumption for the host machine in the work area and an estimated total power consumption for the auxiliary machine in the work area.

7. The method according to claim 1, further comprising determining one or more potential costs for the host machine and the auxiliary machine to traverse a work path across the plurality of work cells in the work area based on the auxiliary power mode assigned to corresponding work cells of the work path.

8. An apparatus for controlling an auxiliary machine connected to a host machine, the apparatus comprising:
a power selector to determine whether the auxiliary machine is to assist the host machine in a plurality of work cells in a work area, and, based on whether the auxiliary machine is to assist the host machine in one of the plurality of work cells, to assign an auxiliary power mode for the one of the plurality of work cells, the auxiliary power mode comprising one of a neutral mode or a power assist mode; and
a controller to control the auxiliary machine in power assist mode to provide auxiliary tractive power in one of the plurality of work cells and to control the auxiliary machine in neutral mode to free wheel in another one of the plurality of work cells.

9. The apparatus according to claim 8, wherein the auxiliary power mode comprises a regenerative braking mode, and the controller is to control the auxiliary machine in one of the plurality of work cells to provide regenerative braking in the regenerative braking mode.

10. The apparatus according to claim 8, wherein an implement is connected to the auxiliary machine, and wherein power mode selector determines whether the auxiliary machine is to assist the host machine in one of the plurality of work cells based upon whether the host machine can solely operate the implement in the one of the plurality of work cells.

11. The apparatus according to claim 10, wherein the host machine operates the implement by at least one of pulling, pushing, or providing power to the implement.

12. The apparatus according to claim 8, wherein an implement is connected to the auxiliary machine and wherein the power mode selector determines whether the auxiliary machine is to assist the host machine in one of the plurality of work cells based on whether the host machine can solely operate the implement at a particular speed in the one of the plurality of work cells.

13. The apparatus according to claim 8, wherein the power mode selector is to assign the power mode for the one of the plurality of work cells by determining at least one of an estimated total power consumption for the host machine in the work area and an estimated total power consumption for the auxiliary machine in the work area.

14. The apparatus of claim 8, further comprising a cost analyzer to determine one or more potential costs of operating the host machine and the auxiliary machine in the plurality of work cells to traverse a work path based on the auxiliary power mode assigned to the corresponding work cells.

15. A tangible computer readable storage medium comprising instructions that, when executed, cause a machine to at least:
determine whether the auxiliary machine is to assist the host machine in a plurality of work cells in a work area;
based on determining whether the auxiliary machine is to assist the host machine in one of the plurality of work cells, assign an auxiliary power mode for the one of the plurality of work cells, the auxiliary power mode comprising one of a neutral mode or a power assist mode; and
in power assist mode, control the auxiliary machine to provide auxiliary tractive power in one of the plurality of work cells, and in neutral mode, control the auxiliary machine to free wheel in another one of the plurality of work cells.

16. The storage medium according to claim 15, wherein the auxiliary power mode comprises a regenerative braking mode, and wherein the instructions, when executed, cause the machine to control the auxiliary machine in one of the plurality of work cells to provide regenerative braking in the regenerative braking mode.

17. The storage medium according to claim 15, wherein an implement is connected to the auxiliary machine, and wherein the instructions, when executed, cause the machine to determine whether the auxiliary machine is to assist the host machine in one of the plurality of work cells based on whether the host machine can solely operate the implement in the one of the plurality of work cells.

18. The storage medium according to claim 17, wherein the host machine operates the implement by at least one of pulling, pushing, or providing power to the implement.

19. The storage medium according to claim 15, wherein the instructions, when executed, cause the machine to assign the auxiliary power mode for the one of the plurality of work cells based on at least on of determining an estimated total power consumption for the host machine in the work area and an estimated total power consumption for the auxiliary machine in the work area.

20. The storage medium according to claim 15, wherein the instructions when executed cause the machine to assign the power mode for the one of the plurality of work cells based on at least one of an estimated total power consumption for the host machine in the work area and an estimated total power consumption for the auxiliary machine in the work area.

21-65. (canceled)
